(19) United States
(12) Patent Application Publication
(10) Pub. No.: US 2018/0189832 A1
(43) Pub. Date: Jul. 5, 2018

(54) METHODS AND SYSTEMS FOR CREATING AND MANAGING USER INTEREST LISTS FOR PROVIDING ONLINE CONTENT

(71) Applicant: Google Inc., Mountain View, CA (US)

(72) Inventors: David Monsees, San Francisco, CA (US); Tom Ayles, Mountain View, CA (US)

(73) Assignee: Google Inc., Mountain View, CA (US)

(21) Appl. No.: 15/463,896

(22) Filed: Mar. 20, 2017

Related U.S. Application Data
(63) Continuation of application No. 13/689,915, filed on Nov. 30, 2012, now abandoned.

(51) Int. Cl. G06Q 30/02

(52) U.S. Cl. CPC G06Q 30/0255

(57) ABSTRACT

Methods, systems, and apparatus for creating and managing user device interest lists for online content are provided. The method is implemented by a processor executing the instructions. The method includes providing a dynamic advertisement including a plurality of elements for display on a user device wherein each element of the dynamic advertisement is configured to receive a device interaction from the user device, receiving data representative of a device interaction with at least one of the plurality of elements, identifying an item based on the data received, and determining a marketing response based on the identified item.

### BACKGROUND

This specification relates to providing online content to a user and, more particularly, to methods and systems for creating and managing user device interest lists which can be used to increase the efficiency of serving online content to a user device.

Interactive media, e.g., media distributed via the Internet, has great potential for improving the serving of online content to receptive audiences. At least some known online content providing systems enable a content provider to display online content on websites not otherwise controlled by the content provider. A first website may provide a list of user device identifiers, which are associated with computing devices that have accessed the first website, to the content providing system to enable the content providing system to serve online content on other websites to the devices associated with the device identifiers included on the provided list that access these other websites. For example, an online retailer may provide to an online content providing system a list of device identifiers for devices that displayed laptops from the online retailer's website. The online retailer may provide laptop-related ads to the ad display network, which will display those ads on devices associated with the list of device identifiers on other websites that are part of the ad display network.

Such so-called remarketing techniques may be limited by the information that can be inferred from the usage of a computing device. For example, an online retailer may be made aware that a computing device has accessed information about laptops, but that online retailer may not know whether the user of that device is actually interested in productivity related laptops or multimedia related laptops. A method for gathering additional data from the computing device to improve the serving of online content to the computing device is certainly desirable to online retailers.

### BRIEF DESCRIPTION OF THE DISCLOSURE

In one embodiment, a computer-implemented method is provided including computer-executable instructions stored on a computer-readable storage media. The method is implemented by a processor executing the instructions. The method includes providing a dynamic advertisement including a plurality of elements for display on a user device wherein each element of the dynamic advertisement is configured to receive a device interaction from the user device, receiving data representative of a device interaction with at least one of the plurality of elements, identifying an item based on the data received, and determining a marketing response based on the identified item.

In another embodiment, a computer system is provided that includes at least one processor and at least one memory comprising computer-executable instructions. When executed by the at least one processor, the computer-executable instructions cause the at least one processor to receive a web request from a user device, and provide a dynamic advertisement and an interaction reporter to the user device, wherein the dynamic advertisement includes a plurality of elements for display on the user device, and wherein each element of the dynamic advertisement is configured to receive a device interaction from the user device. The computer-executable instructions further causing the at least one processor to receive data representative of a device interaction with at least one of the plurality of elements from the interaction reporter, identify an item based on the data received, and determine a marketing response based on the identified item.

In yet another embodiment, computer-readable storage media having computer-executable instructions embodied thereon is provided. When executed by at least one processor, the computer-executable instructions cause the processor to provide a dynamic advertisement including a plurality of elements for display on a user device wherein each element of the dynamic advertisement is configured to receive a device interaction from the user device, receive data representative of a device interaction with at least one of the plurality of elements, identify an item based on the data received, and determine a marketing response based on the identified item.

### BRIEF DESCRIPTION OF THE DRAWINGS

FIGS. 1-3 show exemplary embodiments of the methods and systems described herein.

FIG. 1 is a diagram of an exemplary environment for creating and managing a user interest list.

FIG. 2 is a flow chart of an exemplary method for creating, and/or adding to, a user interest list.

FIG. 3 is a block diagram of exemplary computing devices that may be used to implement the systems and methods described in this document.

Like reference numbers and designations in the various drawings indicate like elements.

### DETAILED DESCRIPTION OF THE DISCLOSURE

Embodiments of the methods and systems described herein enable an interaction detection system to detect interactions of user computing devices with online content, such as dynamic advertisements, displayed on websites that are accessed and served to the user devices. The interaction detection system is configured to identify an item (e.g., a product and/or a service), an attribute of an item, or a category the item or attribute has been associated with based on the interaction and update or create one or more user device interest lists based on the interaction. Additional advertisements may be provided to the user device or other user devices associated with the user device interest list as the user devices are used to navigate to other websites. Although the systems and methods described herein relate to dynamic advertisements, the systems and methods are not limited to such data. Rather, the systems and methods described herein could be used with the displaying of any dynamic online content.

The following detailed description illustrates embodiments of the invention by way of example and not by way of limitation. It is contemplated that the invention has general application to processing web traffic regardless of the type of webserver, how the traffic reaches the webserver, and/or the type of content provided by the webserver.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) providing a dynamic advertisement including a plurality of elements to a user computing device, wherein each element is configured to interact with the user computing device while the user views the dynamic advertisement; (b) receiving data at a computer system, the data representative of a user device interaction with at least one of a plurality of elements; (c) identifying, by a computer system, an item based on data received; (d) determining, by the computer system, a marketing response based on an identified item; and (e) creating and managing a user device interest list based on one or more interactions of the user device controlled by the user with the dynamic advertisement.

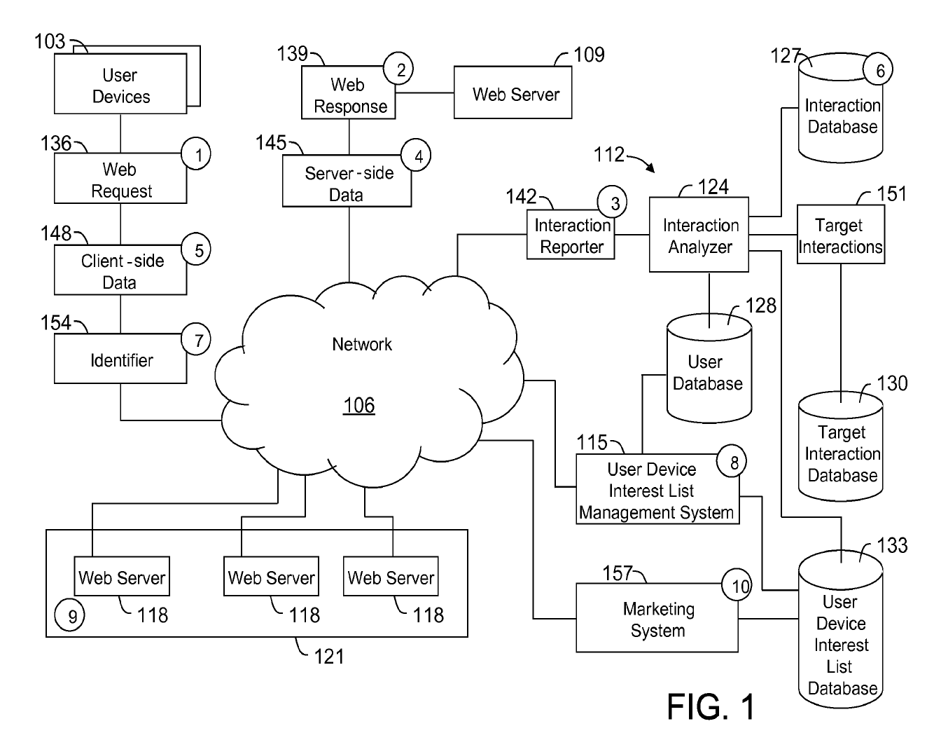

FIG. 1 is a diagram of an exemplary environment 100 for creating and managing a user device interest list. Environment 100 includes user devices 103 (e.g., from which web requests are generated) that are communicatively connected, through a network 106, with a webserver 109, an interaction detection system 112, a user device interest list management system 115, and at least one ad network webserver 118 associated with an ad display network 121. User devices 103, for example, can be used by users who access online resources, such as websites and webpages that are provided by webserver 109. User devices 103 can include, for example, computing devices executing web browsers (e.g., by which users can access the resources). Network 106 can include any combination of the Internet, local area networks (LANs), wide area networks (WANs), and other networks. Actions performed by a user using user device 103 may generate interactions (sometimes referred to as “interaction data”) that are detectable by interaction detection system 112. Interaction detection system 112 includes an interaction analyzer 124, an interaction database 127, a user database 128, a target interaction database 130, and a user device interest list database 133. In one embodiment, interaction analyzer 124 may include a web server.

As used herein, the phrase “web request” includes more than just HTTP/HTTPS requests. For example, web requests may include requests to join a network, DNS requests, and/or any request for access, authentication, data, action, and/or response, communicated using any protocol. Accordingly, responses to web requests may include web content and/or any other appropriate response based on the content of the web request and the protocol used. Though HTTP-based web requests and HTML-based responses are used throughout, it is contemplated that interaction detection system 112 may be used with a variety of protocols, requests, and/or responses that are not limited to just webpages and web content.

In one exemplary flow of FIG. 1, a web request 136 is generated by a user using user device 103 (stage 1). Generally, web request 136 is formed by a web browser executing on user device 103. However, web request 136 may be formed by any software executing on user device 103 and/or by any hardware component of user device 103. Web request 136 includes a request for a web resource, such as a web page, that is accessible via a URL. Web request 136 is routed via network 106 to webserver 109, which is associated with the requested web resource.

In response to web request 136, a web response 139 and an interaction reporter 142 are provided to user device 103 (stages 2 and 3). Web response 139 includes a web page, e.g., in HTML and at least one ad, such as a dynamic ad. An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to or include sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

A dynamic ad is an ad that includes one or more elements or regions that the user may interact with using user device 103. Each element or region may be associated with a separate product or service. The interactions may include, for example, a “mouseover” or “rollover” interaction (i.e., an identification of a time and/or a location at which the user moved a mouse or other pointing device over a region or element of the dynamic ad), a mouse click, a scrolling or movement of the ad (or of a region or element of the ad) by the user, an initiation or a termination of a playback of a media file associated with a region or element of the dynamic ad, or any other suitable interaction. In one embodiment, the dynamic ad is constructed based on known characteristics of the user device (i.e., characteristics of the user device previously identified and/or determined) that are stored within a user profile associated with the user device, for example.

Interaction reporter 142 includes code executable by user device 103 for collecting and transmitting data about user device 103 and the interactions of the user using user device 103 with the ads. For example, and without limiting the generality of the foregoing, interaction reporter 142 may be implemented as a JAVASCRIPT program or script that is executed by the web browser on user device 103. (JAVASCRIPT is a trademark registered to Oracle of Redwood Shores, Calif.) In the exemplary embodiment, web response 139 instructs user device 103 to request interaction reporter 142 from interaction analyzer 124, e.g., using an appropriate HTML tag. In some embodiments, interaction reporter 142 is included in web response 139 provided by webserver 109.

In some embodiments, interaction reporter 142 executes on user device 103 before the web page included in web response 139 is loaded. In other embodiments, interaction reporter 142 executes while the web page included in web response 139 is being loaded. In still other embodiments, interaction reporter 142 executes after the web page included in web response 139 has been loaded.

Web server 109 provides server-side data 145 to interaction analyzer 124 (stage 4) and interaction reporter 142 provides client-side data 148 to interaction analyzer 124 (stage 5). Server-side data 145 and client-side data 148 may include data collected by webserver 109 and interaction reporter 142, respectively. Collected data may include, but are not limited to, web browser type, web browser version, web browser language settings, user device screen size, user device Ethernet MAC address, user device CPU profile, user device network connection type, user device network connection speed, user device web browser cookies, HTTP reference, user device user agent string, and the like. Interaction analyzer 124 also collects data from user device 103, e.g., user interactions with ads as well as cookies presented to interaction analyzer 124 when user device 103 retrieves interaction reporter 142 from interaction analyzer 124.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Interaction analyzer 124 determines one or more products or services (also referred to herein as one or more “items”) that are associated with interactions using data stored in interaction database 127 (stage 6). Interaction database 127 includes data for identifying the products or services associated with the ads displayed to the user. For example, interaction database 127 includes mappings or other data that enable interaction analyzer 124 to determine a product or service that corresponds to an interaction received from user device 103 (through interaction reporter 142). For example, if a dynamic ad includes a plurality of products that are each associated with a region or element within the dynamic ad, interaction database 127 may include a mapping of the regions or elements within the dynamic ad in which each product or service appears. Accordingly, interaction analyzer 124 may use the data from interaction database 127 to correlate a position of the interaction (within the ad) to a product or service displayed by the ad. In another embodiment, interaction analyzer 124 determines an attribute associated with the one or more items (i.e., products or services) or a category the attribute is assigned to, and records this interaction data for later use as described herein. For example, when a user using user device 103 interacts with a plurality of ads showing different computer products, interaction analyzer 124 can determine that these different computer products have a similar attribute (e.g., multimedia laptop) and belong to a defined category. Accordingly, interaction analyzer 124 is configured to determine whether the interactions of user device 103 are associated with a single product, or across multiple products having a similar attribute and belonging to a particular category.

Interaction analyzer 124 also receives one or more target interactions 151 from target interaction database 130. Target interactions 151 are pre-determined interactions that are desirable to detect, and may be specific to web server 109. In one embodiment, each target interaction 151 is associated with one or more user device interest lists stored in user device interest list database 133. For example, target interactions 151 may include a category of interaction types such as mouseovers, mouse clicks, initiations of media playback, or any other interaction type. Target interactions 151 may also include interactions with ads generated by a particular ad company, interactions with ads associated with a particular product manufacturer or service provider, interactions with ads associated with a particular product or service, and/or any other suitable interaction.

Interaction analyzer 124 receives one or more target interactions 151 from target interaction database 130 and determines whether the interactions received from interaction reporter 142 match target interactions 151. If the interactions received from interaction reporter 142 match target interactions 151 (i.e., if interaction analyzer 124 determines that one or more target interactions 151 have occurred), interaction analyzer 124 may update a user device interest list database 133 and/or a user database 128 with the interaction data.

In one embodiment, user database 128 includes a profile of a plurality of users (“user profiles”). The user profile data may include, for example, an identity of the user, an identifier associated with user device 103 used by the user, one or more products that has been associated with the user device as being a product of interest, one or more products the user device has searched for, a history of prior ad interactions, and/or any other suitable data. To comply with privacy concerns and regulations, the user profile data may be maintained in an anonymous manner and may not include personally identifiable information as described above.

In addition, if interaction analyzer 124 determines that one or more of target interactions 151 has occurred, then interaction analyzer 124 may cause an identifier 154 to be associated with user device 103 (stage 7). More particularly, in the exemplary embodiment, interaction reporter 142 sets a cookie on the user device web browser containing identifier 154. Interaction analyzer 124 causes identifier 154 to be associated with each user device interest list in user device interest list database 133 associated with the one or more target interactions 151 that have occurred. In other words, interaction analyzer 124 adds identifier 154 to the user device interest list or lists corresponding to target interaction 151 that occurred.

In some embodiments, interaction reporter 142 is configured to detect target interactions 151 that occur, store an identifier 154, and report identifier 154 to interaction analyzer 124. More particularly, interaction reporter 142 provided in stage 2 may be configured to determine whether user device 103 has caused target interactions 151 to occur. Accordingly, in this embodiment, interaction reporter 142, and not interaction analyzer 124, determines whether a target interaction has occurred. Interaction analyzer 124 may configure interaction reporter 142 based on target interactions 151 prior to providing interaction reporter 142 to user device 103.

User device interest list management system 115 enables advertisers to create and manage ad campaigns directed to one or more user device interest lists (stage 8). For example, user device interest lists may represent, or may be associated with, one or more products or services that one or more user devices have accessed online and thus indicated an interest in by the user. In addition, user device interest lists may represent, or be associated with, one or more attributes of a product or service (e.g., multimedia laptop), wherein the attribute can be used to define, at least in part, a category of products or services. User device interest lists may additionally or alternatively include characteristics of the users of the user devices based on ad interactions and/or based on other known data about the users. User device interest list management system 115 may include a web server for providing an interface to advertisers. User device interest list management system 115 is configured to present user device interest lists from user device interest list database 133. More particularly, the advertiser is able to select a user device interest list from the user device interest lists in user device interest list database 133. For example, the advertiser may select a user device interest list associated with new computers.

User device interest list management system 115 is further configured to generate composite user device interest lists, i.e., user device interest lists based on two or more user device interest lists, using mathematical, logical, and/or set operations on the user device interest lists in user device interest list database 133. For example, a first user device interest list may be directed to user devices indicating an interest by users in new computers, and a second user device interest list may be directed to user devices indicating an interest by users in digital movies. Using addition, logical AND, and/or unions, the advertiser may create, using list management system 115, a composite list of user devices indicating an interest by users in new computers that are tailored or optimized for media playback (e.g., for playing digital movies). The first user device interest list may be associated with a first ad interaction by the user device, and the second user device interest list may be associated with a second ad interaction by the user device. Accordingly, a plurality of user device interactions with a plurality of dynamic ads may be gathered and analyzed to determine one or more user device interest lists and/or to determine a marketing response.

Advertisers may select or provide ads to be displayed to users associated with user device interest lists, whether composite or otherwise. More specifically, the ads from advertisers are associated with the corresponding user device interest lists and both the ads and the association may be stored in user device interest list database 133 or in a separate database.

When an identified user device, i.e., a user device having an identifier, visits a webserver 118 associated with ad display network 121 (stage 9), the user's user device 103 provides the identifier to a marketing system 157. Marketing system 157 determines a user device interest list or lists associated with the identifier using user device interest list database 133 (stage 10). Marketing system 157 causes an ad associated with the user device interest list to be displayed to the user, e.g., within a web page provided by webserver 118.

While webserver 109 is described as capturing new user devices for user device interest lists and webservers 118 are described as displaying ads based on user device interest lists, it should be appreciated that both tasks may be performed by the same webserver. Moreover, while the various stages have been presented in numerical order, stages may occur in any order and may occur concurrently.

In a particular example, a user using user device 103 may cause web request 136 to be generated for w.com, a website hosted by web server 109 that provides weather information. Interaction reporter 142 and a web response, including a dynamic ad, are provided to user device 103 by web server 109, for example. Interaction reporter 142 and web server 109 provide client-side data 148 and server-side data 145, respectively, to interaction analyzer 124. Interaction analyzer 124 receives target interactions 151 from target interaction database 130. In this example, target interactions 151 include mouseover interactions associated with dynamic ads. In other words, interaction detection system 112 is configured to detect mouseover interactions that were initiated by the user, using user device 103, in response to a dynamic ad impression.

After the dynamic ad is displayed to the user (i.e., the ad impression occurs), the user interacts with the ad using user device 103 by “mousing over” portions of the dynamic ad, such as one or more regions of the dynamic ad that display a product or a service that the user is interested in. In one example, the user hovers the mouse over a region of the dynamic ad that displays a laptop computer for sale. Interaction reporter 142 identifies the interactions with the dynamic ad and reports, or transmits, the interaction and associated data to interaction analyzer 124.

Interaction analyzer 124 receives the interaction data from interaction reporter 142 and determines whether one or more target interactions 151 occurred. If a target interaction 151 occurred, interaction analyzer 124 accesses interaction database 127 to determine which product or service (or attribute associated with a product or service) that was displayed in the ad corresponds to the interaction. In the example described herein, interaction analyzer 124 determines, based on the location of the interaction within the ad, that the user moved a mouse over a picture of a laptop offered for sale. Interaction analyzer 124 receives additional data for the identified product from interaction database 127 and associates the product and the product data with the interaction. For example, interaction analyzer 124 receives data indicating the product manufacturer, the product seller, the product model number, and/or any other suitable product data.

In one embodiment, interaction analyzer 124 stores an identifier 154 on user device 103 including the product data and the interaction data. Identifier 154 may be used to display further ads, such as remarketing ads, displayed or served to the user and/or the product identified by the interaction. Alternatively, no identifier 154 is stored, and the product data and the interaction data are only used to update user database 128 and/or user device interest list database 133 as described herein.

User device interest list management system 115 updates the user profile in user database 128 and updates one or more user device interest lists in user device interest list database 133 based on the detected interaction. More specifically, the user profile is updated based on the interaction data and/or based on the data about the product or service the user device interacted with. For example, if the user profile indicated that the user device has been used to search for a significant amount of movies or other multimedia content, the user profile may be updated to indicate that the user of the user device is searching for a laptop and that the user may be interested in laptops optimized for multimedia playback. In such a manner, the existing data known about the user and/or user device 103 may be synthesized and/or updated to include the data learned about the most recent ad interactions. Thus, ads and other content may be displayed to the user through user device 103 to more fully align with the user's interests.

In addition, a user device interest list may be created or updated within user device interest list database 133. For example, user device interest list management system 115 may use a real-time or near-real time process or another process to determine which user devices have indicated an interest by a user in a product based on interactions with the product displayed in one or more ads. More specifically, user device interest list management system 115 compares a number of interactions of each user device with a threshold number of interactions to determine that a user device has indicated a sufficient level of interest in the product by a user of the user device. If the number of interactions exceeds the threshold, user device interest list management system 115 creates a user device interest list associated with the product. If a user device interest list has already been created for the product, user device interest list management system 115 updates the user device interest list based on the interaction data and/or upon the determination that the number of interactions exceeds the threshold. In one embodiment, the user device interest list includes an identifier for each user device and may also include a number and/or a type of interaction that the user device had with the ad displaying the product. In addition, the threshold may be computed across an aggregate of user device interactions, as well as for just a single user device. For example, the system described herein can compare a number of interactions of each user device with a threshold number of interactions. The system can also compare the number of interactions from all user devices with the threshold amount, and create a new user device list by adding each user device involved to that list once the threshold is met.

A marketing response is determined by marketing system 157 based on the updated user device interest list and/or updated user profile (i.e., based on the ad interaction). For example, additional ads may be identified and displayed to the user through user device 103 based on the interaction data. Continuing with the example described above, further ads directed to laptops, or multimedia optimized laptops, may be served to each user device included in the user device interest list.

As another example, the marketing response may include adjusting a price associated with a second advertisement for the product based on the interaction. For example, if the user profile data and the user device interest list indicate that the user is interested in purchasing the product soon, a second ad for the product may be generated with a lower price listed to encourage the user to buy the product. In another embodiment, the price charged to an ad company or to a retailer may be adjusted for a second advertisement based on a user interaction with a first advertisement. For example, the price charged for the second advertisement may be increased because the interaction with the first advertisement indicated that the user is interested in a particular product. The above-described marketing responses should be viewed as exemplary only, and not limiting.

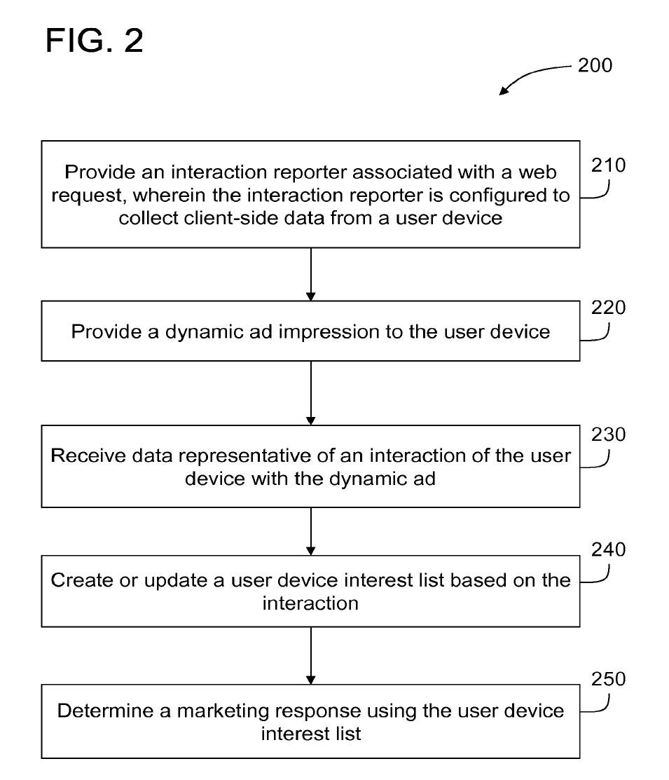

FIG. 2 is a flow chart of an exemplary method 200 for creating, and/or adding to, user device interest lists in accordance with one embodiment of the present invention. Method 200 includes stages that can be implemented as computer-executable instructions that are executed by one or more processors in one or more computer systems. In some implementations, method 200 can be performed by user device 103, webserver 109, interaction analyzer 124, and user device interest list management system 115.

A user using a user device, e.g., user device 103, sends a web request to a webserver, e.g., webserver 109. Webserver 109 responds to the web request and causes an interaction reporter, e.g., interaction reporter 142, to be provided 210 to user device 103. Interaction reporter 142 collects client-side data from user device 103 and transmits the data to interaction analyzer 124, for example. The client-side data is received by interaction analyzer 124. It should be recognized that server-side data may also be received from webserver 109.

A dynamic ad impression is provided 220 to the user through user device 103. The dynamic ad includes a plurality of regions that are each associated with one or more different products and/or services, or with different features or aspects of the product and/or service. Interaction reporter 142 determines whether the user, using user device 103, interacts with one of the regions of the dynamic ad and transmits data representative of the interaction to interaction analyzer 124.

Interaction analyzer 124 receives 230 data representative of the interaction of the user device with the dynamic ad and determines whether an item (e.g., a product and/or a service) was interacted with by the user device during the impression of the dynamic ad. In another embodiment, interaction analyzer 124 determines whether the user device has interacted with an item having a particular attribute associated with a defined category during the impression of a dynamic ad for the item.

A user device interest list is created or updated 240 based on the interaction. For example, if no user device interest lists have been created for the product or service, user device interest list management system 115 creates 240 a user device interest list associated with the product or service that was determined to be interacted with by the user using user device 103. However, if a user device interest list already exists for the product or service, user device interest list management system 115 updates 240 the user device interest list with the interaction data. More specifically, user device interest list management system 115 compares a number of interactions of each user device with a threshold number of interactions to determine that a user using user device 103 has expressed a sufficient level of interest in the product. If the number of interactions exceeds the threshold, user device interest list management system 115 creates a user device interest list associated with the product. The threshold may be computed across an aggregate of user interactions, as well as for just a single user. For example, the system described herein can compare a number of interactions of each user device with a threshold number of interactions; or the system can also compare the number of interactions from all user devices with the threshold amount, and create a new user device list by adding each user device involved to that list once the threshold is met.

A marketing response is determined 250 using the user device interest list. For example, one or more ads may be delivered to users identified in the user device interest list, or in a plurality of user device interest lists (or composite user interest lists).

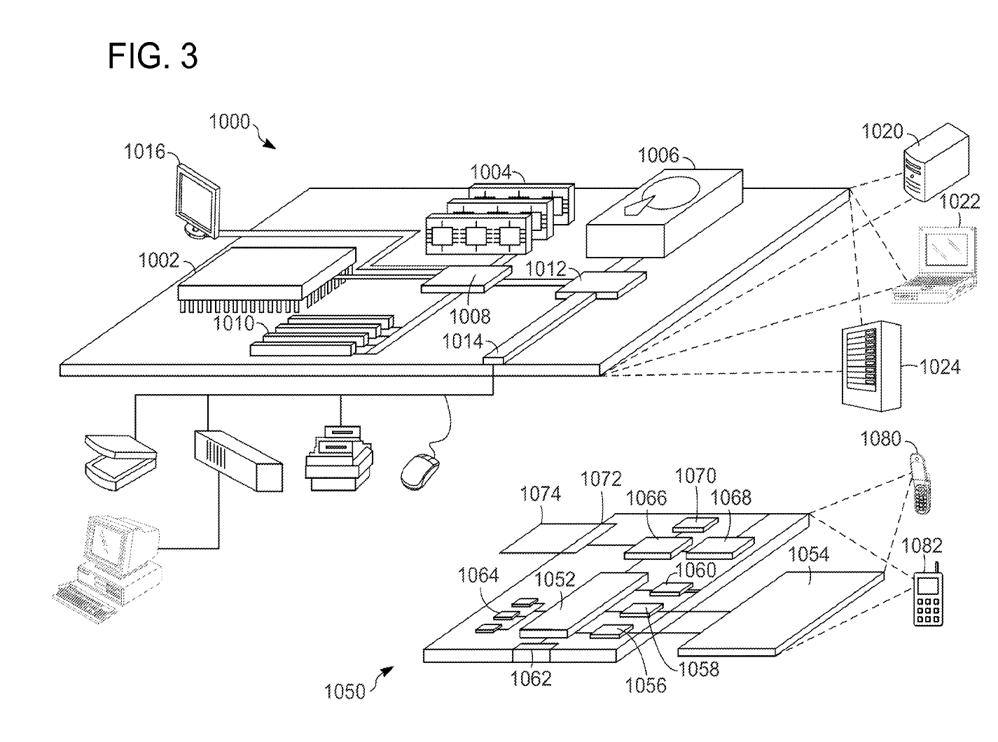

FIG. 3 is a block diagram showing example or representative computing devices and associated elements that may be used to implement the systems of FIG. 1. FIG. 3 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

1-27. (canceled)

28. A data processing system for automatically generating product or service attribute specific interest lists, the data processing system comprising:
at least one processor; and
at least one memory comprising computer-executable instructions that, when executed by the at least one processor, cause the at least one processor to:
provide, to a set of client devices, a plurality of composite content items, each composite content item including a respective plurality of interactive regions associated with a respective plurality of products or services and each interactive region including content related to a respective product or service different from products or services associated with other interactive regions of the composite content item, and an interaction reporting module, the interaction reporting module configured to execute on the set of client devices to cause the set of client devices to detect and report interactions with each interactive region of the composite content items;
receive, from the set of client devices, interaction data sets representative of a plurality of interaction events, each interaction data set i) corresponding to an interaction event performed at a respective composite content item, ii) identifying an interactive region of the respective composite content item of the plurality of composite content items, and iii) including an identifier of a client device associated with the interaction event of the set of client devices;
map, for each interactive data set, the interactive region identified in that interactive data set to a corresponding product or service;
determine, for each interactive data set, based on the mappings between interactive regions of the received interaction data sets and the corresponding products or services, one or more product or service attributes to which to assign that interactive data set;
assign, to a first attribute specific group of a plurality of attribute specific groups corresponding to the one or more product or service attributes, a subset of the interactive data sets that correspond to a first product or service attribute of the plurality of product or service attributes;
determine, for the first product or service attribute, that a number of interaction events exceeds a predetermined threshold value; and
generate a first interest list for the first product or service attribute, the first interest list including identifiers corresponding to a subset of the set of client devices associated with the assigned subset of interactive data sets.

29. The data processing system of claim 28, wherein, when executed by the at least one processor, the computer-executable instructions further cause the at least one processor to:
associate a content item of a content provider with the first interest list; and
provide the content item for presentation on a first client device of the subset of the set of client devices based on the association between the content item and the first interest list.

30. (canceled)

31. The data processing system of claim 28, wherein, when executed by the at least one processor, the computer-executable instructions further cause the at least one processor to:
receive, from a client device of the set of client devices, other interaction data indicative of one other interaction event associated with the first product or service attribute; and
update the first interest list to include an identifier of the client device.

32. The data processing system of claim 28, wherein the first interest list is specific to a pair including a first client device and the first product or service attribute, and wherein, when executed by the at least one processor, the computer-executable instructions further cause the at least one processor to:
receive, from the set of client devices, second interaction data sets representative of a plurality of second interaction events, each second interaction data set associated with a corresponding second interaction event related to the first product or service attribute;
determine that a number of the second interaction events exceeds the predetermined threshold value;
create a second interest list for a second client device and the first product or service attribute pair, the second interest list including, or associated with, an identifier of the second client device; and
merge the first interest list and the second interest list into a third interest list for the first product or service attribute.

33. The data processing system of claim 28, wherein, when executed by the at least one processor, the computer-executable instructions further cause the at least one processor to:
update a profile associated with a first client device of the subset of the set of client devices using the interaction events corresponding to the first product or service attribute.

34. The data processing system of claim 28, wherein a product or service attribute includes a specific product or service or a product or service category;

35. The data processing system of claim 28, wherein the interaction reporting module is configured to detect and report one or more predefined types of interactions.

36. The data processing system of claim 35, wherein the one or more predefined types of interactions include at least one of:
a mouseover interaction;
a click;
a scrolling interaction; and
initiation or termination of a playback of a media file.

37. A computer-implemented method for automatically generating product or service attribute specific interest lists, the computer-implemented method comprising:
providing, by one or more computer servers, to a set of client devices, a plurality of composite content items, each composite content item including a respective plurality of interactive regions associated with a respective plurality of products or services and each interactive region including content related to a respective product or service different from products or services associated with other interactive regions of the composite content item, and an interaction reporting module, the interaction reporting module configured to execute on the set client devices to cause the set of client devices to detect and report interactions with each interactive region of the composite content items;
receiving, by the one or more computer servers, from the set of client devices, interaction data sets representative of a plurality of interaction events, each interaction data set corresponding to an interaction event performed at a respective composite content item, identifying an interactive region of the respective composite content item of the plurality of composite content items, and including an identifier of a client device associated with the interaction event of the set of client devices;
mapping, by the one or more computer servers, for each interactive data set, the interactive region identified in that interactive data set to a corresponding product or service;
determining, by the one or more computer servers, for each interactive data set, based on the mappings between interactive regions of the received interaction data sets and the corresponding products or services, one or more product or service attributes to which to assign that interactive data set;
assigning, by the one or more computer servers, to a first attribute specific group of a plurality of attribute specific groups corresponding to the one or more product or service attributes, a subset of the interactive data sets that correspond to a first product or service attribute of the plurality of product or service attributes;
determining, by the one or more computer servers, for the first product or service attribute, that a number of interaction events exceeds a predetermined threshold value; and
generating, by the one or more computer servers, a first interest list for the first product or service attribute, the first interest list including identifiers corresponding to a subset of the set of client devices associated with the assigned subset of interactive data sets.

38. The computer-implemented method of claim 37 further comprising:
associating, by the one or more computer servers, a content item of a content provider with the first interest list; and
providing, by the one or more computer servers, the content item for presentation on a first client device of the subset of the set of client devices based on the association between the content item and the first interest list.

39. (canceled)

40. The computer-implemented method of claim 37, further comprising:
receiving, by the one or more computer servers, from a client device of the set of client devices, other interaction data indicative of one other interaction event associated with the first product or service attribute; and
updating, by the one or more computer servers, the first interest list to include an identifier of the client device.

41. The computer-implemented method of claim 37, wherein the first interest list is specific to a pair including a first client device and the first product or service attribute, the computer-implemented method further comprising:
receiving, by the one or more computer servers, from the set of client devices, second interaction data sets representative of a plurality of second interaction events, each second interaction data set associated with a corresponding second interaction event related to the first product or service attribute;
determining, by the one or more computer servers, that a number of the second interaction events exceeds the predetermined threshold value;
creating, by the one or more computer servers, a second interest list for a second client device and the first product or service attribute pair, the second interest list including, or associated with, an identifier of the second client device; and
merging, by the one or more computer servers, the first interest list and the second interest list into a third interest list for the first product or service attribute.

42. The computer-implemented method of claim 37, further comprising:
updating, by the one or more computer servers, a profile associated with a first client device of the set of client devices using the interaction events corresponding to the first product or service attribute.

43. The computer-implemented method of claim 37, wherein a product or service attribute includes a specific product or service or a product or service category;

44. The computer-implemented method of claim 37, wherein the interaction reporting module is configured to detect and report one or more predefined types of interactions.

45. The computer-implemented method of claim 44, wherein the one or more predefined types of interactions include at least one of:
a mouseover interaction;
a click;
a scrolling interaction; and
initiation or termination of a playback of a media file.

46. A non-transitory computer-readable medium including computer code instructions stored thereon, the computer code instructions, when executed by one or more processors, cause the one or more processors to:
provide, to a set of client devices, a plurality of composite content items, each composite content item including a respective plurality of interactive regions associated with a respective plurality of products or services and each interactive region including content related to a respective product or service different from products or services associated with other interactive regions of the composite content item, and an interaction reporting module, the interaction reporting module configured to execute on the set of client devices to cause the set of client devices to detect and report interactions with each interactive region of the composite content items;
receive, from the set of client devices, interaction data sets representative of a plurality of interaction events, each interaction data set corresponding to an interaction event performed at a respective composite content item, identifying an interactive region of the respective composite content item of the plurality of composite content items, and including an identifier of a client device associated with the interaction event of the set of client devices;
map, for each interactive data set, the interactive region identified in that interactive data set to a corresponding product or service;
determine, for each interactive data set, based on the mappings between interactive regions of the received interaction data sets and the corresponding products or services, one or more product or service attributes to which to assign that interactive data set;
assign, to a first attribute specific group of a plurality of attribute specific groups corresponding to the one or more product or service attributes, a subset of the interactive data sets that correspond to a first product or service attribute of the plurality of product or service attributes
determine, for the first product or service attribute, that a number of interaction events exceeds a predetermined threshold value; and
generate a first interest list for the first product or service attribute, the first interest list including identifiers corresponding to a subset of the set of client devices associated with the assigned subset of interactive data sets.

47. The non-transitory computer-readable medium of claim 46, wherein the computer code instructions, when executed by one or more processors, further cause the one or more processors to:
associate a content item of a content provider with the first interest list; and
provide the content item for presentation on a first client device of the subset of the set of client devices based on the association between the content item and the first interest list.
